(19) United States
(12) Patent Application Publication
(10) Pub. No.: US 2008/0172387 A1
(43) Pub. Date: Jul. 17, 2008

(54) Speeding up traversal of a file system tree

(76) Inventors: Olaf Manczak, Hayward, CA (US); Eric Jason Kustarz, San Francisco, CA (US)

Correspondence Address: BROOKS KUSHMAN P.C. / SUN / STK, 1000 TOWN CENTER, TWENTY-SECOND FLOOR, SOUTHFIELD, MI, 48075-1238, US

(21) Appl. No.: 11/654,148

(22) Filed: Jan. 16, 2007

(51) Int. Cl. G06F 7/08

(52) U.S. Cl. 707/7

(57) ABSTRACT

A method for traversing a file system tree on a storage device includes obtaining a list of entries within a directory of the file system tree. The list of entries is sorted in order of the file locations on the storage device. The entries within the list of entries are accessed for tree traversal in order in which they are sorted.

### TECHNICAL FIELD

Embodiments of the invention relate generally to file systems, and more particularly to traversal of a file system tree.

### BACKGROUND

FIG. 1 shows an example of one type of a storage device 51. The example storage device 51 is a hard disk drive and has a housing 70, magnetic disks 73, actuators 71, a spindle motor 72, heads 74 for reading/writing data, a mechanism control circuit 75 for controlling mechanism portions such as the heads 74, a signal processing circuit 76 for controlling a read/write signal of data from/to each magnetic disk 73, a communication interface circuit 77, an interface connector 79 for inputting/outputting various commands, and a power supply connector 80 which are all disposed in the housing 70. Other types of storage devices are available, such as CDs, DVDs, tape-based storage or MEMS-based storage devices. Disk drives are discussed herein as an example of one embodiment of a storage device.

The recording medium for the storage device, e.g., disks 73, contains a number of files of different types including directory files, i.e., files which identify other files, and non-directory files, for example, data or application files. Typically, these files are organized according to a structure known as a directory tree. The number of files that can be stored on the hard disk drive 51 depends on the capacity of the disks 73. Typically, a disk drive with capacity C can hold N files of with file average size Savg, where N=C /Savg. Disk drives now typically have a capacity C of up to 750 Gigabytes, and the average file size may be as small as 10-100 bytes for files that contain SMS messages or 100-1000 bytes for typical emails.

Accordingly, a typical 400 Gigabytes disk drive, can hold just under 100 million files having an average size of 4096 bytes, for example, which must be managed efficiently to keep response times small and to optimize the use of the storage device.

With such a large number of small-sized files in a file system, the average number of files in a single directory can be very large. The average number of files in a single directory tree may depend on how deep the directory tree is. For instance, the average number of files in a single directory may vary from about 100 (if a directory tree is four levels deep) to about 465 (if the directory tree is three levels deep) to about 10,000 (if the directory tree is two levels deep). With such a large number of small files, file operations, such as file system backup, that traverse the directory tree and access each file data, can take a very long time. Backup of a disk drive and similar operations involve traversal of the file system tree and reading data of each file in order of the traversal. This is particularly true if the files were created in a random order, i.e. when file location in the directory tree is not correlated with the physical location on disk. Of course, disk drive backup represents just one example from a more general class of disk workloads to which the problem applies.

FIG. 2 illustrates an example of a hierarchical file system 300 depicting a block diagram view of a file tree structure having a large number of entries. The illustrative file system 300 has 100,000,000 files and is two levels deep with 10,000 files per level. The hierarchical file system 300 comprises root directory 302, sub-directories 304, 306, and 308 flowing from root directory 302, and data files 320-328 of the directories 304, 306 and 308. As shown, the file system 300 has 10,000 directories, each directory including 10,000 files each. Thus, each directory has a large number of entries.

Modern disk drives can access data in a sequential rate of 40-100 Megabytes per second (millions of bytes per second). This rate of data access is controlled in great part by a product of bytes per track multiplied by rotations per second. At the rate of 40 Megabytes (1 Megabyte=1000,000 bytes) per second it takes roughly 10,000 seconds to access all the data a 400 Gigabyte disk may contain. Seek time is the time period to position the actuator 71 (FIG. 1) from the current head and cylinder position to the new target head and cylinder position. Times between 10 and 20 milliseconds (ms) for seek times are common. At the rate of 40 Megabytes per second it takes about 0.1 ms to read 4096 bytes from disk, while an average seek between two random locations on the disk takes approximately 10 ms.

FIG. 3 illustrates a flowchart of a prior art method 100 performed by an application to traverse a file system tree to read file data. At block 101, for a directory, the application performs a system call to obtain a list of file entries in the directory of a file system tree. An example of a system call to obtain a list of file entries in a directory is a “readdi” call. The readdir function can return the directory entries in an arbitrary order. Typically, the order is defined by the natural order of traversing the underlying data structure (e.g., linked list, hash table or btree).

At block 111, the application accesses files in the directory in the order returned by the call to the file system. At blocks 121 and 131, for each entry, the method 100 determines if the entry is itself a directory. If so, then control returns to block 101. Otherwise, if the entry is not a directory and is a file on disk, at block 141, the method 100 seeks to the file on disk and at block 151, reads the content of the file.

On average the time taken to search a file on disk between two random locations on the disk (approximately 10-20 ms) is much larger than the time taken to actually read the file (approximately 0.1 ms). Therefore, the time taken to traverse the files in the directory of the file system tree with a large number of files can be dominated by the seek operations and can be 100 to 200 times greater than the time needed to read the disk data sequentially.

One solution to speed up traversal of a file system tree is to perform block level operations that access data sequentially. Such block level operations take up to a few hours, and thus, are significantly faster. However, due to issues relating to user convenience and flexibility, file mode, in which the directory tree traverses and accesses each file in the directory, is more desirable than the block mode.

### SUMMARY

A method for traversing a file system tree on a storage device, such as a disk drive, includes obtaining a list of entries within a directory of the file system tree on the storage device. The list of entries is sorted in order of the file locations on the storage device. The entries within the list of entries are accessed for tree traversal in order in which they are sorted.

Embodiments of the present invention are described in conjunction with systems, methods, and machine-readable media of varying scope. In addition to the aspects of the embodiments of the invention described in this summary, further aspects of the embodiments of the invention will become apparent by reference to the drawings and by reading the detailed description that follows.

### BRIEF DESCRIPTION OF THE DRAWINGS

One or more embodiments of the present invention are illustrated by way of example and not limitation in the figures of the accompanying drawings, in which like references indicate similar elements, and in which:

FIG. 1 illustrates an example configuration of a hard disk drive;

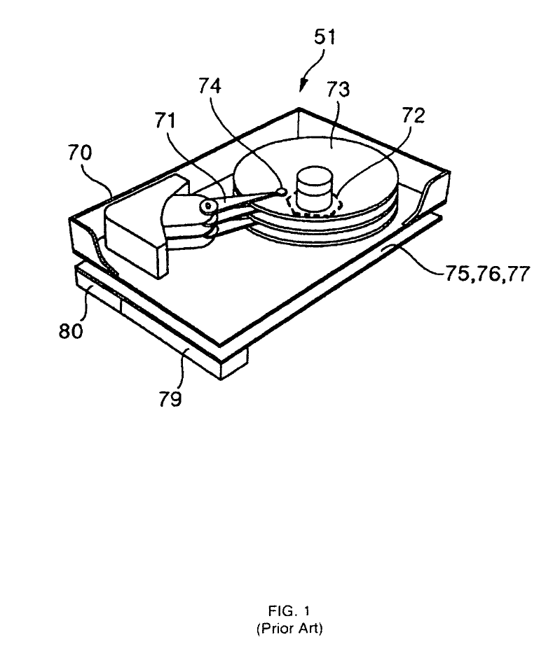

FIG. 2 illustrates an example of a prior art hierarchical file system;

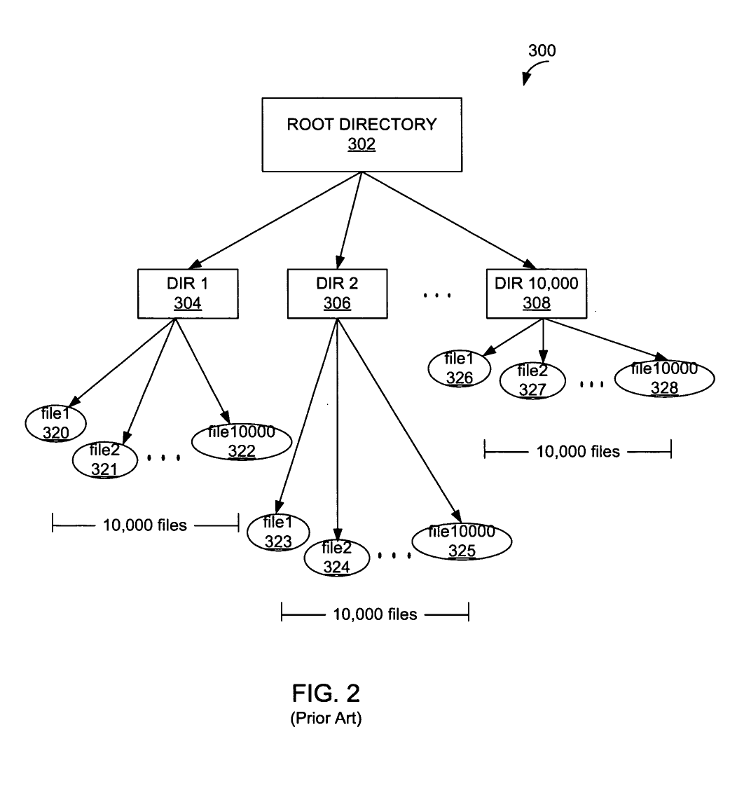

FIG. 3 is a flowchart of a prior art method to be performed to back up files in a file system tree;

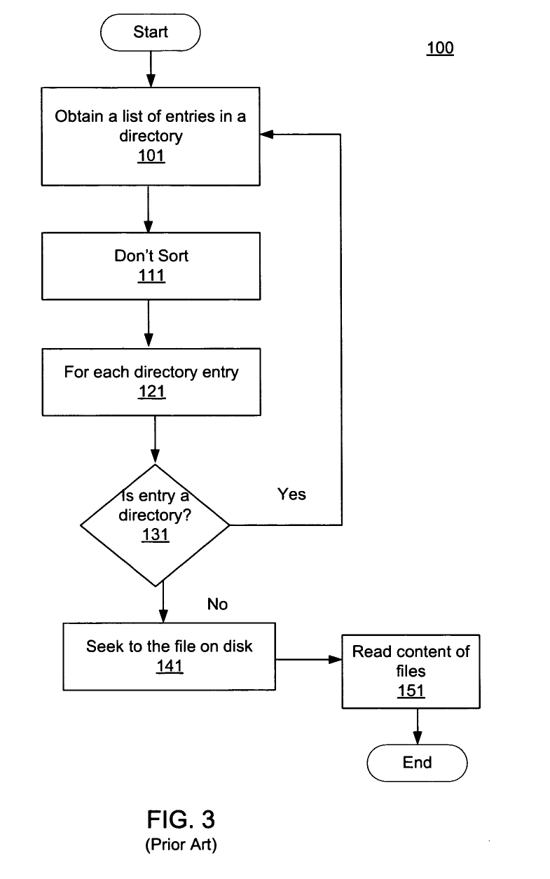

FIG. 4 is a flowchart of a method to traverse a file system tree according to an embodiment of the invention; and

FIG. 5 is a diagram of one embodiment of a computer system suitable for use in conjunction with embodiments of the invention.

### DETAILED DESCRIPTION

A method and system for improving performance of file system tree traversal to access files on a storage device are described herein. Files located in a single directory are read in the order of their physical locations on the storage device rather that in the order the file entries are kept in the directory structure. Accordingly, the average seek time between individual read requests is reduced. Consequently, the total elapsed time for file system tree traversal is significantly reduced, especially for a file system tree with a very large number of files, because the seek distances (and seek times) between consecutive files are smaller.

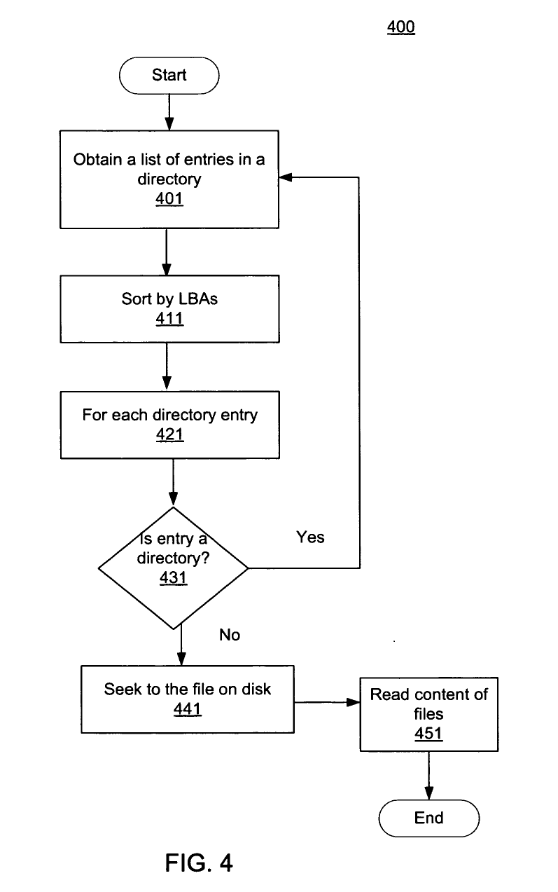

FIG. 4 illustrates a flowchart of a method 400 performed by an application to traverse a file system file system tree to read file data according to one embodiment of the present invention. At block 401, for a directory, the application performs a system call to obtain a list of file entries in a directory. An example of a system call to obtain a list of file entries in a directory is the readdir call.

At block 411, the list of file entries is sorted in the order of the file locations on the storage device. For each file, the file system maintains a list of blocks that contain data of such a file. For small files all the data blocks are typically consecutive because they occupy only one or a few blocks (disk blocks, for example, are typically 512 bytes). In one embodiment, the file system can sort directory entries according to the logical block addresses of the first block used by each file. In another embodiment, the file system sorts the list of file entries based on the track number and/or sector number of the location of the file on the disk drive.

Accordingly, block 411 utilizes the concept that most modern storage device technologies, such as disk drive technologies, use logical block addresses (LBAs) that number available data blocks in a consecutive way. An LBA is used to address a specific location on a disk, or within a stack of multiple disks, for example, and is mapped by the disk controller to a cylinder or track, head number indicating a particular head in a multi-disk system, and sector. For example, typically block ‘0’ is located on at the beginning of a first track on a first cylinder, and the block with the highest available number is the last block on a last track on a last cylinder.

At block 421 and 431, for each entry in the directory, the method 400 determines if the entry is itself a directory. If so, then control returns to block 401. Otherwise, if the entry is not a directory and is a file on the storage device, at block 441, the method 100 seeks to the file on the storage device and at block 451, reads the content of the file.

Thus, because the time taken to search a file on disk between two locations on the disk that are close by (approximately 2 ms) is smaller than the time taken to search a file on disk between two random locations on the disk (approximately 10 ms-20 ms), the time taken to traverse the files in the directory of the file system tree is reduced. In the example case of a hard disk drive embodiment, the disk head for a hard disk drive would not need to travel to distant portions of the disk to read a first file and then back to another portion to read a next file.

A reason why the seek time between files is smaller after sorting is because a seek between two disk location consists of radial seek (comprising an actuator move) and rotational seek in the case of a hard disk drive. Time taken by actuator movements between nearby cylinders can be as short as 1-2 ms while the movements between distant cylinders can take 10-20 ms. Also rotational seeks between locations on the same or nearby cylinders can take time shorter than a half of the rotation. Thus, seek times between locations sorted according to their LBAs can be much shorter than average seek times for a given disk type.

To illustrate, if a list of 465 (an average number of files if the directory tree is three levels deep) to about 10,000 files (an average number of files if the directory tree is two levels deep) is sorted in the order of their disk locations, then the average seek time between consecutive locations can be reduced by approximately 5-10 times. While the seek operation will still dominate over read operation in terms of time, the overall time to access the data will be approximately 5-10 times smaller. Accordingly, process 400 may be used to improve performance of traversal of large file systems that have a very large number of files that are small in size. Further, process 400 may be applied to multiple file systems and to various existing and future storage devices in which seek time between close locations is much shorter than between distant locations.

In the foregoing description, the invention has been described with reference to magnetic disk based storage devices. However, the invention applies to any storage device in which seek time between two locations with distant addresses takes substantially more time than a seek between two addresses that are close by. For instance, the invention can be used to traverse a file system tree on a storage device that is tape-based storage, has a rotating disk or employs MEMS-based storage.

In practice, the method 400 may constitute one or more programs made up of machine-executable instructions. Describing the method with reference to the flowchart in FIG. 4 enables one skilled in the art to develop such programs, including such instructions to carry out the operations (acts) represented by logical blocks 401 until 451 on suitably configured machines (the processor of the machine executing the instructions from machine-readable media). The machine-executable instructions may be written in a computer programming language or may be embodied in firmware logic or in hardware circuitry. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic, and so on), as taking an action or causing a result. Such expressions are merely a shorthand way of saying that execution of the software by a machine causes the processor of the machine to perform an action or produce a result. It will be further appreciated that more or fewer processes may be incorporated into the method illustrated in FIG. 4 without departing from the scope of the invention and that no particular order is implied by the arrangement of blocks shown and described herein.

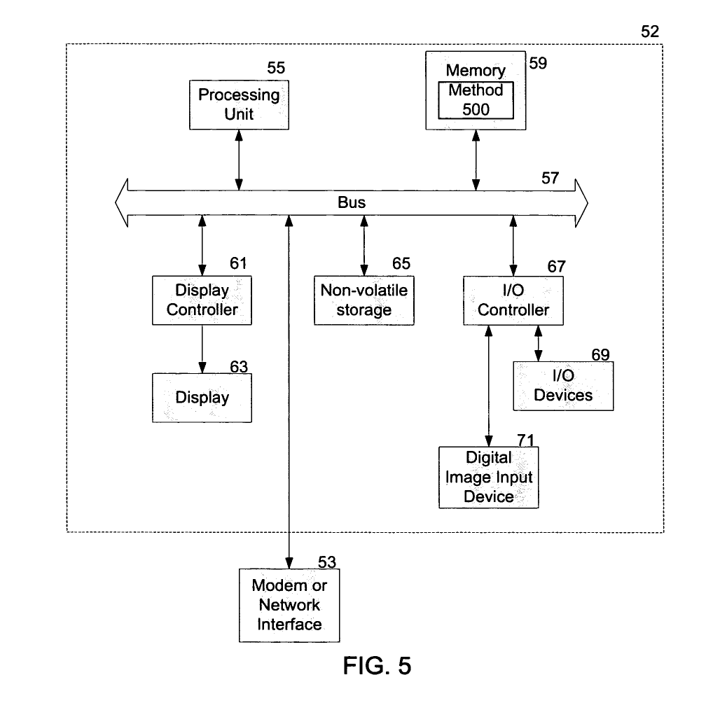

The following description of FIG. 5 is intended to provide an overview of computer hardware and other operating components suitable for performing the methods of the invention described above, but is not intended to limit the applicable environments. One of skill in the art will immediately appreciate that the embodiments of the invention can be practiced with other computer system configurations. FIG. 5 shows one example of a conventional computer system that can be used as a client computer system or a server computer system or as a web server system. The computer system 52 interfaces to external systems through the modem or network interface 53. It will be appreciated that the modem or network interface 53 can be considered to be part of the computer system 52. This interface 53 can be an analog modem, ISDN modem, cable modem, token ring interface, satellite transmission interface, or other interfaces for coupling a computer system to other computer systems. The computer system 52 includes a processing unit 55, which can be a conventional microprocessor such as an Intel Pentium microprocessor, Motorola Power PC microprocessor, or a Sparc-based microprocessor. Memory 59 is coupled to the processor 55 by a bus 57. Memory 59 can be dynamic random access memory (DRAM) and can also include static RAM (SRAM). The bus 57 couples the processor 55 to the memory 59 and also to non-volatile storage 65 and to display controller 61 and to the input/output (I/O) controller 67. The display controller 61 controls in the conventional manner a display on a display device 63 which can be a cathode ray tube (CRT) or liquid crystal display (LCD). The input/output devices 69 can include a keyboard, disk drives, printers, a scanner, and other input and output devices, including a mouse or other pointing device. The display controller 61 and the I/O controller 67 can be implemented with conventional well known technology. A digital image input device 71 can be a digital camera which is coupled to an I/O controller 67 in order to allow images from the digital camera to be input into the computer system 52. The non-volatile storage 65 is often a magnetic hard disk, an optical disk, or another form of storage for large amounts of data. Some of this data is often written, by a direct memory access process, into memory 59 during execution of software in the computer system 52. One of skill in the art will immediately recognize that the terms “computer-readable medium” and “machine-readable medium” include any type of storage device that is accessible by the processor 55 and also encompass a carrier wave that encodes a data signal.

It will be appreciated that the computer system 52 is one example of many possible computer systems which have different architectures. For example, personal computers based on an Intel microprocessor often have multiple buses, one of which can be an input/output (I/O) bus for the peripherals and one that directly connects the processor 55 and the memory 59 (often referred to as a memory bus). The buses are connected together through bridge components that perform any necessary translation due to differing bus protocols.

It will also be appreciated that the computer system 52 is controlled by operating system software which includes a file management system, such as a disk operating system, which is part of the operating system software. The file management system is typically stored in the non-volatile storage 65 and causes the processor 55 to execute the various acts required by the operating system to input and output data and to store data in memory, including storing files on the non-volatile storage 65.

The present invention also relates to apparatus for performing the operations herein. This apparatus may be specially constructed for the required purposes, or it may comprise an electronic tester selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

In the forgoing specification, the invention has been described with reference to specific exemplary embodiments. It will, however, be evident that various modifications and changes may be made thereto without departing from the broader spirit and scope of the invention. The specification and drawings are accordingly to be regarded in an illustrative sense rather than a restrictive sense.

What is claimed is:

1. A computerized method for traversing a file system tree on a storage device comprising:
sorting a list of entries within a directory of the file system tree in order of the physical location of the entries on the storage device; and
accessing the entries within the list of entries in order in which they are sorted.

2. The method recited in claim 1, wherein the list of entries is sorted based on logical block addresses of a block used by files within the list of entries.

3. The method recited in claim 1, wherein the entries are accessed for backing up the entries.

4. The method recited in claim 1, further comprising obtaining the list of entries within the directory of the file system tree.

5. The method recited in claim 1, wherein a seek time between two locations on the storage device with distant addresses is substantially more than a seek time between two locations with nearby addresses.

6. The method recited in claim 5, wherein the storage device is one of a magnetic disk drive, a tape-based storage device, or a MEMS-based storage device.

7. A machine-readable medium having executable instructions to a cause a machine to perform a method comprising:
sorting a list of entries within a directory of a file system tree on a storage device in order of a physical location of the entries on the storage device; and
accessing the entries within the list of entries in order in which they are sorted.

8. The machine-readable medium recited in claim 7, wherein the list of entries is sorted based on logical block addresses of a block used by files within the list of entries

9. The machine-readable medium recited in claim 7, wherein the entries are accessed for backing up the entries.

10. The machine-readable medium recited in claim 7, further comprising obtaining the list of entries within the directory of the file system tree.

11. The machine-readable medium recited in claim 7, wherein a seek time between two locations on the storage device with distant addresses is substantially more than a seek time between two locations with nearby addresses.

12. The machine-readable medium recited in claim 11, wherein the storage device is one of a magnetic disk drive, a tape-based storage device, or a MEMS-based storage device.

13. A computerized system comprising:
a processor coupled to a memory through a bus; and
a process executed from the memory by the processor to cause the processor to:
sort a list of entries within a directory of a file system tree on a storage device in order of a physical location of the entries on the storage device; and
access the entries within the list of entries in order in which they are sorted.

14. The system recited in claim 13, wherein the list of entries is sorted based on logical block addresses of a block used by files within the list of entries.

15. The system recited in claim 13, wherein the entries are accessed for backing up the entries.

16. The system recited in claim 13, further comprising obtaining the list of entries within the directory of the file system tree.

17. The system recited in claim 13, wherein a seek time between two locations on the storage device with distant addresses is substantially more than a seek time between two locations with nearby addresses.

18. The system recited in claim 17, wherein the storage device is one of a magnetic disk drive, a tape-based storage device, or a MEMS-based storage device.
